(19) United States
(12) Patent Application Publication
(10) Pub. No.: US 2006/0156474 A1
(43) Pub. Date: Jul. 20, 2006

(54) Multi-purpose rescue tool

(76) Inventor: Chris Gillingham, Meadville, PA (US)

Correspondence Address: OLIFF & BERRIDGE, PLC, P.O. BOX 19928, ALEXANDRIA, VA, 22320, US

(21) Appl. No.: 11/232,042

(22) Filed: Sep. 22, 2005

Related U.S. Application Data
(60) Provisional application No. 60/643,593, filed on Jan. 14, 2005.

(51) Int. Cl. B25B 7/22

(52) U.S. Cl. 7/129; 7/166

(57) ABSTRACT

The multi-purpose rescue tool includes a pair of opposed jaw members pivoted together so that the working end portions of the jaw members move toward and away from each other. A pair of handles extends from each jaw member such that the handles can move about a pivot axis for opening and closing the jaw members. One handle includes a pry bar for prying open windows and doors, a socket wrench for closing water/gas valves, and a seat belt cutter for cutting restraining harnesses. The other handle includes a glass punch for breaking glass and a spanner wrench for performing a variety of operations including connecting/disconnecting fire hoses and opening fire hydrants.

### CROSS-REFERENCE TO RELATED APPLICATION

This application claims the benefit of U.S. Provisional Application Ser. No. 60/643,593 filed on Jan. 14, 2005, the subject matter of which is hereby incorporated in its entirety by reference thereto.

### BACKGROUND

This invention relates generally to multi-purpose tools, and more particularly to multi-purpose tools used in emergency situations, such as firefighting and vehicle rescue operations.

During emergency situations, such as firefighting or vehicle rescue operations, rescue and/or emergency personnel must perform many tasks that require the use of a variety of tools. For example, emergency personnel typically use a spanner wrench to connect and disconnect firefighting hose connections while fighting fires. Another tool often used while fighting a fire is a pry bar or crowbar, which is generally used to pry open window sashes and doors to gain access into buildings. Additionally, a slotted wrench or socket wrench is commonly used to close gas valves and prevent explosions in a fire situation. Furthermore, the emergency personnel often use a pair of pliers, such as lineman's pliers, needle nose pliers, or sheet metal cutters, to perform multiple jobs that involve gripping, sheering, turning, cutting, or twisting operations.

At other types of emergencies, such as vehicle accidents, rescue or emergency personnel will often encounter a situation where a window needs to be broken or a seat belt and/or shoulder harness needs to be cut. The rescue personnel will generally use a cutting blade, such as a razor blade or knife, to cut the seat belt in order to free the occupant. Additionally, the rescue personnel may have to remove or shatter the window using a specially designed tool, such as a glass breaking spike or a spring loaded window punch. Some multi-purpose tools, such as a spanner wrench include an open slot, which has a razor blade that cuts seat belts or other body restraints in order to free the victim.

As recognized by emergency personnel or rescuers, the key to saving lives is not wasting time searching for a tool they need. Accordingly, it is very beneficial to the rescuer to have a multi-purpose rescue tool, which incorporates a diverse range of tools often used in performing their job.

There are multi-purpose tools that try to combine some of the tools used by emergency personnel. For example, some multi-purpose tools include a spanner wrench with a slot that is adaptable to close a gas valve or a spanner wrench with a tapered handle that can be used to open windows and doors to gain access therein. Still other multi-purpose tools try to include a variety of different tools, such as cutting blades, wrenches, screwdrivers, knife blades and scissors. Although many of these tools are useful in certain emergency or rescue situations, many of these tools fall short of providing a multi-purpose tool that can be used in a variety of emergency situations due to their limited design or intended use in a particular emergency situation. Thus, there is a need for a multi-purpose rescue tool that can be used in a diverse variety of emergency situations.

### SUMMARY

There is a need for a multi-purpose rescue tool that is adaptable for use in a large variety of emergency situations and which can incorporate a diverse range of tools often used by emergency personnel and rescuers in performing their job.

In order to resolve the above-mentioned problems, one aspect is to provide a multi-purpose rescue tool with a diverse range of tools often used by emergency personnel and rescuers in performing their jobs.

Another aspect is to incorporate a diverse range of tools into one multi-purpose tool such that the tools are easily accessible and functional for their intended purpose.

A further aspect is to incorporate a diverse range of tools into one multi-purpose tool such that each tool performs its required task efficiently without interference or obstruction from the other tools.

A still further aspect is to incorporate a diverse range of tools into one multi-purpose tool such that each tool is used in succession. Thus, saving time by not having to search for a particular tool to perform a particular job or having to change the structural configuration of the multi-purpose tool.

A multi-purpose rescue tool is provided that is designed and configured for use in a variety of emergency situations. One embodiment of the multi-purpose rescue tool includes opposing cooperating first and second jaw members joined about a pivotal axis for swinging movement thereof. The jaw members are configured to define a pair of pliers, such as a lineman's pliers, needle nose pliers, or other suitable pliers. Additionally, the jaw members are configured to define cutters, such as wire or sheet metal cutters.

The first and second jaw members include working end portions having opposing inner surfaces or faces. The working end portions of the jaw members are configured for swinging movement relative toward and away from each other about the axis of a pivot, such that the working end portions open/close. The opposing inner surfaces or faces may include a plurality of teeth or ridges for gripping, turning, twisting, and rotating an object removably disposed between the working end portions.

The first and second jaw members include first and second handles. The first and second handles extend in a generally longitudinal direction away from and with respect to an axis along the length of corresponding working end portions.

An end portion of the first handle includes a finger, which defines a glass punch adaptable for breaking glass. The end portion of the first handle also includes a first wrench, such as a spanner wrench, which is configured to perform a variety of operations including, but not limited to, connecting/disconnecting fire hoses and opening fire hydrants.

An end portion of the second handle includes a pry bar, crowbar, lever arm, and/or wedge having a distal end, which is tapered or flatten for prying and holding open windows and doors.

The second handle also includes a second wrench, such as a socket wrench or slotted wrench, which is configured to open/close water and/or gas valves.

The second handle includes an arm, which defines a seat belt cutter for cutting a seat belt or restraining harness.

A more detailed description of the preferred embodiments is provided below.

### BRIEF DESCRIPTION OF THE DRAWINGS

The disclosure will be presented with reference to the drawings in which:

FIG. 1 is a left side perspective view of an embodiment of a multi-purpose rescue tool;

FIG. 2 is a right side perspective view of the multi-purpose rescue tool of FIG. 1;

FIG. 3 is a top perspective view of the multi-purpose rescue tool of FIG. 1; and

FIG. 4 is a bottom perspective view of the multi-purpose rescue tool of FIG. 1.

### DETAILED DESCRIPTION OF EMBODIMENTS

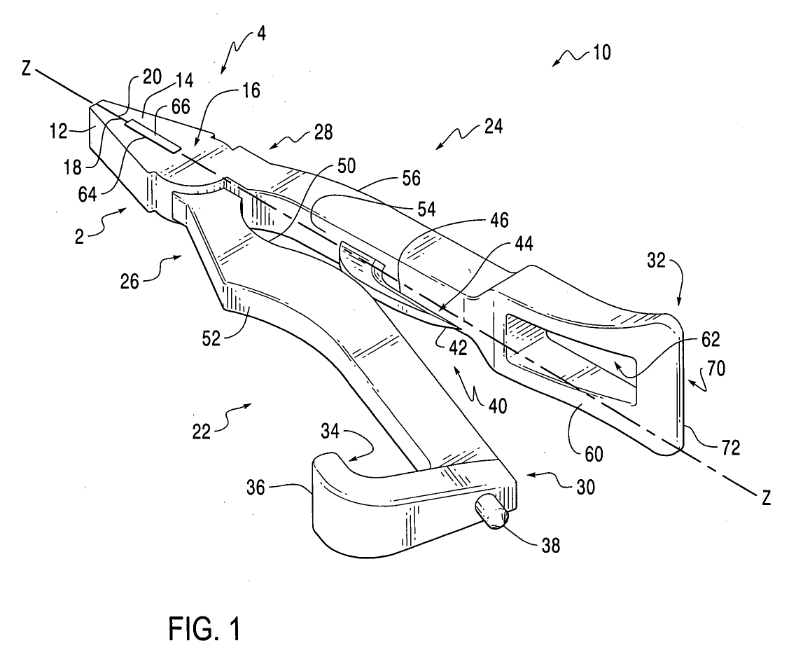

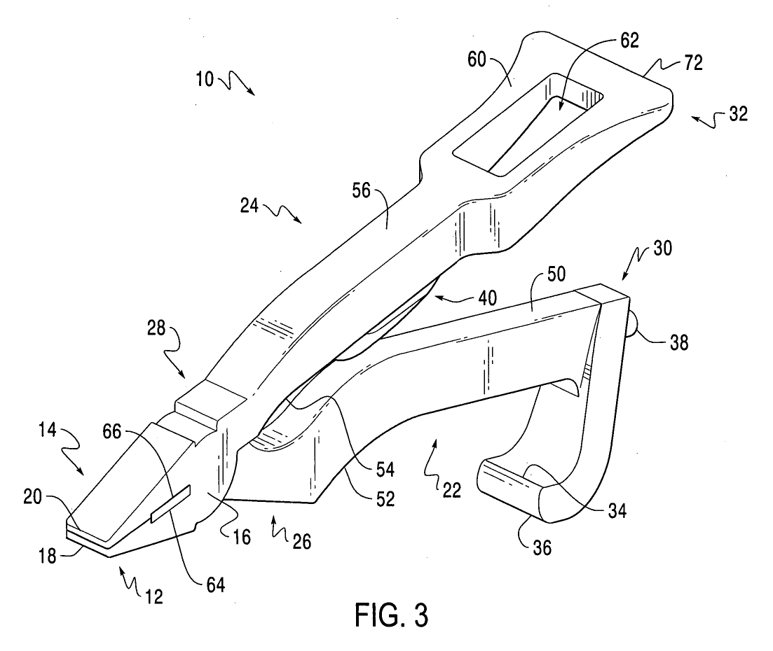

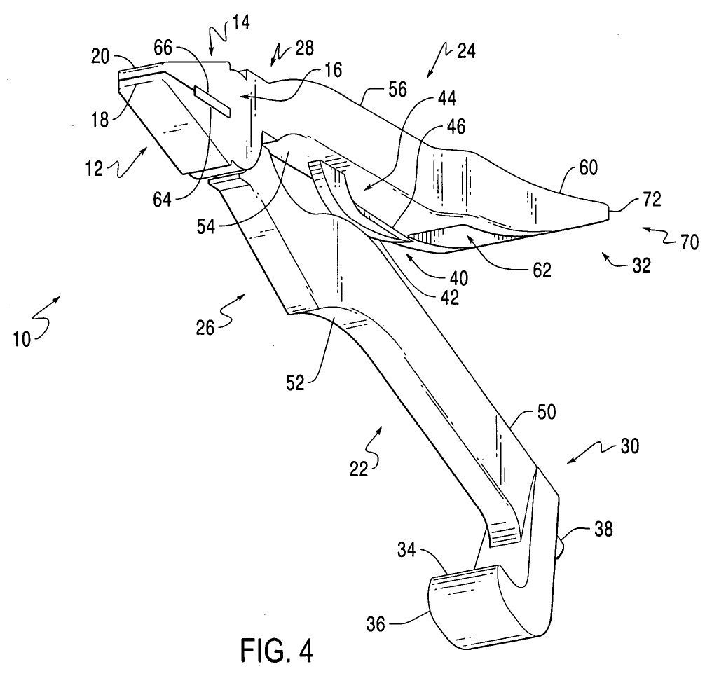

FIGS. 1-4 are an exemplary embodiment of a tool, such as, for example, a multi-purpose rescue tool, designated generally as 10 in the drawings. The tool 10 includes opposing cooperating first and second members 2, 4, respectively. First and second members 2, 4 define opposing cooperating first and second jaw members 12, 14 for gripping, sheering, turning, cutting, or twisting operations. First and second jaw members 12, 14 include working end portions 18, 20. Working end portions 18, 20 are integrally connected to first and second jaw members 12, 14, respectively. First and second jaw members 12, 14 are pivotally, moveably, swingably, and/or rotatably connected, attached, and/or joined together for movement about a pivot, axis, shaft, pin, or point 16. For example, first and second jaw members 12, 14 are pivotally joined together about pivotal axis 16 for swinging movement of working end portions 18, 20 relatively toward and away from each other, such that working end portions 18, 20 move from an open position to a close position and vice versa. The working end portions 18, 20 may extend in a generally coplanar direction with respect to each other. The working end portions 18, 20 extend in a generally forwardly direction with respect to pivotal axis 16.

As FIGS. 1-4 show, the working end portions 18, 20 are configured to move from an open position to a closed position in which opposing or facing inner surfaces of the working end portions 18, 20 are in clamping, gripping, or cutting engagement. For example, each working end portions 18, 20 has opposing inner surfaces or faces that includes at least one of a plurality of ridges, teeth, and/or ribs configured for gripping, twisting, rotating, and/or turning an object removably engaged between working end portions 18, 20. Additionally, the inner surfaces of at least one working end portion 18, 20 may have an abrasive, rubber, or anti-slip surface and/or coating applied thereto for extra grip. For example, the ridges of working end portions 18, 20 are coated with an abrasive, rubber, or anti-slip coating so that first and second jaw members 12, 14 can apply a rotational force to an object, such as a fastener, without slipping off or disengaging from the fastener under wet conductions. Further, the working end portions 18, 20 include a pair of cutters 64, 66 that are designed and configured to cut or sever wire dispose therebetween. The pair of cutters 64, 66 is configured to cut a range of wire gauges from small gauge to large gauge, including gauges the size of a chain. Accordingly, the pair of cutters 64, 66 would be commensurate with the anticipated gauge wire to be cut.

The first and second jaw members 12, 14 are configured and designed to define and/or form, for example, a pair of pliers, such as, for example, lineman's pliers, needle nose pliers, pump pliers, long-nose pliers, diagonal pliers, side-cutting pliers, round nose pliers, bent nose pliers, or any other suitable pliers. The pliers formed may be in combination with the cutters 64, 66 as described or limited to pliers alone. Additionally, first and second jaw members 12, 14 may be configured and designed to define and/or form a pair of specialized cutters, such as, for example, diagonal cutters, cable cutters, chain cutters, wire cutters, sheet metal cutters or other suitable cutters in lieu of the gripping/cutting combination previously described.

The first and second jaw members 12, 14 include first and second handles 22, 24, respectively. First and second handles 22, 24 extend in a generally rearward direction with respect to pivotal axis 16. First and second handles 22, 24 are integrally connected and/or joined to first and second jaw members 12, 14, respectively. The first and second handles 22, 24 extend in a generally longitudinal direction relative to a central axis Z or reference plane of tool 10. The central axis Z or reference plane of tool 10 being defined from a closed position of corresponding working end portions 18, 20 and extending along the length of tool 10, the reference plane incorporates axis Z and in parallel to the faces of working end portions 18, 20 when in contact. Portions of the outer surfaces of first and second handles 22, 24 may be coated with a rubber or anti-slip coating for preventing an operator's hand from slipping off or losing grip during operation of tool 10. For example, a rubber coating is applied over portions of the outer surface of first and second handles 22, 24 that are normally held by the operator.

First and second jaw members 12, 14 may include tang, shank, or butt portions configured for removable engagement with first and second handles 22, 24. Alternatively, the first and second handles 22, 24 may include tang, shank, or butt portions configured for removable engagement with first and second jaw members 12, 14. For example, first and second handles 22, 24 are removably engaged, connected, and/or joined to each tang or butt portion of first and second jaw members 12, 14 by a fastener. The fastener may be any suitable fastener, such as a pin, dowel, cotter pin, keeper, screw, key, rivet, bolt and nut assembly, or any combination or equivalent thereof. The interchangeable arrangement between various types of jaw members provides an efficient way to quickly adapt different types or kinds of jaw members of the tool 10 for particular tasks or operations. For example, a pair of lineman's pliers may be removed from the first and second handles 22, 24, and a pair of needle nose pliers may be connected to first and second handles 22, 24. Also, the first and second jaw members 12, 14 may be detachably joined to the first and second handles 22, 24 by, for example, a detent connection. The detent connection including, but not limited to, a latch detent connection, a tab detent connection, a ball and socket connection, a snap-on connection, a slotted detent pin/spring connection, an expandable clip connection, a spring and pin connection, and/or a hose type connection. For example, the first and second handles 22, 24 include at least one ball that is configured to engage with at least one socket of respective first and second jaw members 12,14 for joining thereof. To disengage the first and second handles 22, 24 from respective first and second jaw members 12, 14, for example, the ball is pressed down and released from the socket.

The first and second handles 22, 24 include forward end portions 26, 28 and rearward end portions 30, 32. The forward end portions 26, 28 are integrally connected to first and second jaw members 12, 14, respectively. Alternatively, forward end portions 26, 28 are removably connected to tang, shank, or butt portions of first and second jaw members 12, 14. Forward end portions 26, 28 may also define tang, shank, or butt portions adapted and configured to removable engagement with first and second jaw members 12, 14. The rearward end portions 30, 32 are disposed at the opposite end of first and second jaw members 12, 14 with respect to working end portions 18, 20. Alternatively, the rearward end portions 30, 32 include or define at least one tang, shank, or butt portion extending therefrom. The tang, shank, or butt portion is configured such that a variety of shapes and tools are mounted, threaded, or joined thereto. The tools, for example, mounted to the rearward end portions 30, 32 may include, but are not limited to, screw driver, Philips head, pick, chisel, wedge, ax, and point, such as a sharp, blunt, or flat point for breaking glass. A fastener, threaded connection, or detent connection fastens, joins, or mounts the tool to at least one of the rearward end portions 30, 32. For example, a tang and screw driver may be detachably joined together by a detent connection, such as, for example, a latch detent connection, a tab detent connection, a ball and socket connection, a snap-on connection, a slotted detent pin/spring connection, an expandable clip device, a spring and pin connection, and/or a hose type connection.

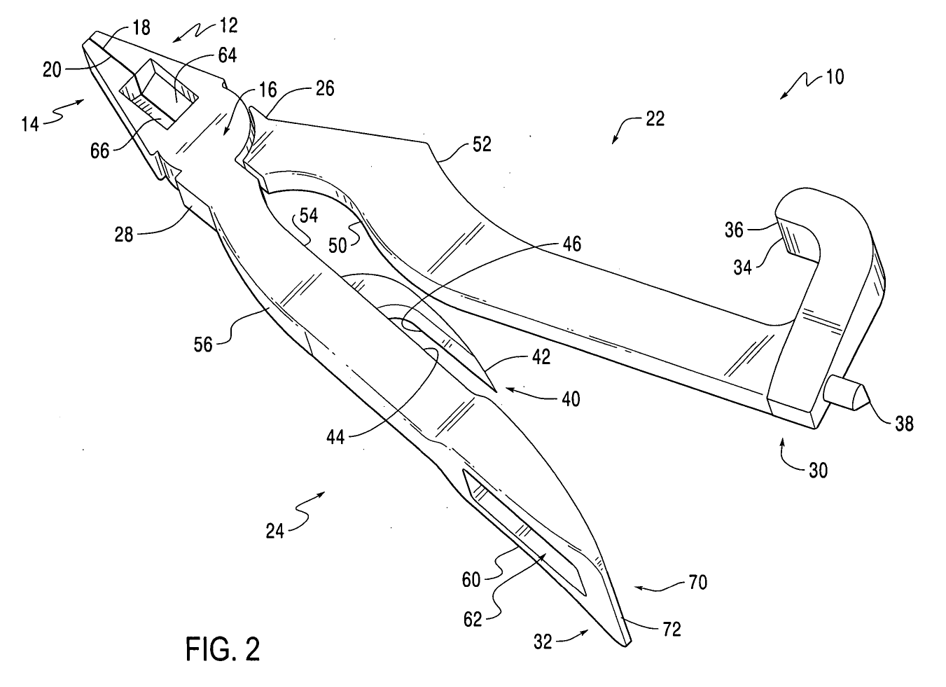

As FIGS. 2-4 illustrate, the first handle 22 includes an inner surface 50. The inner surface 50 includes at least a portion thereof having a generally straight, incline, arcuate, curve, bow, concave, or convex shape. For example, the inner surface 50 is configured to define a S-shaped handle with one leg of the S-shape handle being elongated. The first handle 22 includes an outer surface 52, which includes at least a portion thereof having a generally straight, arcuate, curve, incline, bevel, recess, convex, or concave shape. For example, the outer surface 52 is configured such that a portion thereof gradually curves inwardly towards the central axis Z of the tool 10 to define a concave surface for an operator's hand to press and/or rest against while operating the tool 10. The first handle 22 is configured to provide a comfortable grip and easy range of motion during operation of tool 10 by a person's hand.

As FIGS. 1-4 show, the second handle 24 includes an inner surface 54. The inner surface 54 includes at least a portion thereof having a generally straight, curve, arcuate, bow, incline, recess, bevel, or concave, or convex shape. For example, the inner surface 54 is configured such that a portion thereof curves away from the central axis Z of tool 10. An outer surface 56 of the second handle 24 includes at least a portion thereof having a generally straight, curve, arcuate, incline, bevel, bow, concave, or convex shape. The inner surface 54 of rearward end portion 32 is also configured to gradually slope, bow, or curve away from the central axis Z of tool 10. The second handle 24 is configured to provide a comfortable grip and easy range of motion during operation of tool 10 by a person's hand.

Referring again to FIGS. 1-4, the rearward end portion 30 of the first handle 22 includes a first wrench 36. The first wrench 36 defines an open-end wrench or spanner wrench. The first wrench 36 is integrally connected to rearward end portion 30. Alternatively, the first wrench 36 is detachably mounted or joined to rearward end portion 30. For example, different size wrenches may be interchangeably mounted to rearward end portion 30 by a fastener, threaded or detent connection. The first wrench 36 is configured to removably engage hose connections, pipe couplings, and/or fire hydrant connections for rotation movement thereof. The first wrench 36 is positioned on the rearward end portion 30 and extends away from or perpendicular to the outer surface 52 to form a generally U-shape or C-shape opening. Alternatively, the shape could form a shape having an increasing opening form the base to fit a large number of nut sizes. For example, the shape of the first wrench 36 could be a generally tapered or trapezoidal shape with one end of the trapezoid being open, such that the first wrench 36 accommodates a large variety of nut sizes that are either metric or English sizes. The first wrench 36 includes a lip or at least one tooth 34 extending from the opening, which is configured to fit into a recess opening, such as a hose coupling. The lip or tooth 34 extends partially inward towards the outer surface 52 from the C-shape or U-shape opening.

A finger 38 is disposed on the rearward end portion 30 of the first handle 22 for striking and breaking objects, such as glass as found in vehicle and building windows. The finger 38 extends from an end portion of the rearward end portion 30 along, for example, the central axis of and in a generally coplanar direction with respect to the first handle 22. Additionally, the finger 38 may be threaded into an opening provided on the rearward end portion 30. For example, the finger 38 includes a shaft having partial threads thereon for threaded engagement with an opening disposed on the end of the rearward end portion 30. The finger 38 is configured to form a point or spike, such as a glass punch or glass-breaking spike. The finger 38 is designed and configured to taper down to a point, so that the impact force applied by finger 38 to an object, such as a window, concentrates the load on the desired location to maximize the stress for breaking the glass of the window. The point of the finger may also be blunt or flat. Alternatively, the finger 38 may be positioned anywhere on the tool 10 for breaking glass, such as, for example, on either outer surfaces 52, 56 of first and second handles 22, 24. The C-shape opening of first wrench 36 provides extra protection when an operator is using finger 38 to break glass. For example, the operator's hand rests against the inside surface of the C-shape opening, thus, preventing the operator's hand from contacting the window or glass being broken.

As FIGS. 1, 2, and 4 illustrate, the second handle 24 includes an arm 40. The arm 40 defines a cutter, such as a seat belt cutter for cutting seat belts. The arm 40 is disposed on the inner surface 54 of the second handle 24. The arm 40 is interposed between forward end portion 28 and rearward end portion 32. The arm 40 includes an opening facing in a generally rearward direction with respect to rearward end portion 32. For example, the arm 40 includes a hook portion 42 extending in a generally rearward and parallel direction with respect to inner surface 54, such that the hook portion 42 defines an opening 44. The opening 44 defines an open slot cutter. For example, an inside surface of the hook portion 42 includes a cutting edge portion 46 for cutting materials, such as seat belts and/or restraining harnesses. The arm 40 has a rounded L-shape with the opening facing rearward with respect to pivotal axis 16. The arm 40 is positioned at approximately midway between the forward end portion 28 and the rearward end portion 32. The arm 40 may also be positioned anywhere on the inner surface 54 as required for proper operation of the tool 10. For example, the arm 40 is positioned closer to the rearward end portion 32 to allow handles 22, 24 to move freely toward and away from each other when opening and closing first and second jaw members 12, 14. The hook portion 42 includes a portion thereof that tapers to a point for guiding the material being severed along the cutting edge portion 46.

As FIGS. 1-4 show, the second handle 24 includes a second wrench 60, such as, for example, a socket wrench, box-end wrench, or slotted wrench. The second wrench 60 is disposed or positioned at approximately the rearward end portion 32. The rearward end portion 32 defines the second wrench 60. The second wrench 60 is designed and configured to fit over or around the handles/valve controls of gas and water valves for opening and closing the valves. The second wrench 60 has a generally rectangular, square, trapezoidal, hourglass, oval, or oblong shape. The second wrench 60 includes an opening 62, which extends through the second handle 24 or, alternatively, is partially recessed in the inner or outer surfaces 54, 56. The opening 62 has a generally rectangular, square, oblong, oval, or tapered opening or slot. The opening 62, for example, has a tapered opening to accommodate a large variety of nut sizes including both metric and English sizes.

The rearward end portion 32 of the second handle 24 generally defines a pry bar, lever arm, crowbar, and/or wedge 70 having a distal end 72. The distal end 72 is tapered or flatten for prying and holding open closely fitted objects. The distal end 72 slopes or curves away from the central axis Z of tool 10. The pry bar and/or wedge 70 is configured for prying and holding open objects, such as, for example, doors and windows or window sashes. The pry bar and/or wedge 70 has a generally arcuate or bow shape. The inner surface 54 of the pry bar and/or wedge 70 slopes away from the hook portion 42 of arm 40, such that the material, for example, a seat belt, is guided into and along the cutting edge portion 46 of arm 40 without interference from the pry bar and/or wedge 70.

In accordance with one of the embodiments described above, a tool comprises opposing cooperating first and second jaw members. A pivot swingably connects the first and second jaw members for pivotal movement relative to each other. Each one of the first and second jaw members includes a working end portion extending from the pivot in a generally forward direction and a tang portion extending from the pivot in a generally rearward direction. A pair of first and second handles includes a forward end portion connected to each one of the tang portions and a rearward end portion extending in a generally longitudinal axis away from the first and second jaw members. The rearward end portion of the first handle is shaped to form a spanner wrench. A finger is disposed on the rearward end portion of the first handle and extends therefrom along a central axis of and in a general coplanar direction with respect to the first handle. A seat belt cutter extends from an inner surface of the second handle. The rearward end portion of the second handle is shaped to form a pry bar or wedge. A socket wrench is disposed in the rearward end portion.

In addition to the features above, the jaw members can define a pair of lineman's pliers.

In addition to the features above, the jaw members can define a pair of needle nose pliers.

In addition to the features above, the jaw members can define a pair of sheet metal cutters.

In addition to the features above, the finger defines a glass punch for breaking glass.

In addition to the features above, the spanner wrench extends generally perpendicular to the outer surface of the first handle to form a generally C-shape opening.

In addition to the features above, the seat belt cutter includes a hook portion with an open slot cutter, which has a cutting edge portion for cutting seat belts.

In addition to the features above, the socket wrench defines a generally rectangular shape with an opening for fitting over a handle of a valve for opening and closing the valve.

In addition to the features above, the socket wrench defines a generally tapered shape for fitting over and engaging a variety of sizes of valve controls for opening and closing the valves.

In addition to the features above, the seat belt cutter is positioned at approximately midway between the forward and rearward end portions of the second handle.

In addition to the features above, the first and second handles are removably connected to each one of the tang portions by a fastener.

In addition to the features above, either one of first and second handles may include the various tool implementations described above. For example, the first handle includes the second wrench and the second handle includes the first wrench. Accordingly, either end portion of the first and second handles may accommodate either one of the first and second wrenches. Additionally, the finger may be disposed on the second handle. Likewise, the arm may be disposed on either of the first or second handles.

The present examples and embodiments are to be considered as illustrative and not restrictive and the multi-purpose rescue tool is not to be limited to the details given herein, but may be modified within the scope and equivalence of the appended claims.

What is claimed is:

1. A multi-purpose rescue tool, the tool comprising:
opposing cooperating first and second jaw members, the first and second jaw members pivotally joined together for swinging movement relative to and fro each other;
a pair of first and second handles extending from respective cooperating first and second jaw members, the first and second handles having respective first and second rearward end portions;
a first wrench disposed on the first rearward end portion;
a finger extending from the first rearward end portion;
an arm disposed on an inner surface of one of the first and second handles; and
a second wrench disposed on the second rearward end portion.

2. The tool according to claim 1, wherein the first wrench defines a spanner wrench.

3. The tool according to claim 1, wherein the second wrench defines a slotted wrench.

4. The tool according to claim 1, wherein the second rearward end portion comprises a pry bar.

5. The tool according to claim 1, wherein the first wrench defines a tapered shape for fitting over and engaging a variety of nut sizes.

6. The tool according to claim 1, wherein the arm is disposed on the second handle, the arm includes a hook portion having a tapered end for guiding a material being severed by a cutting edge surface.

7. The tool according to claim 1, wherein the first and second jaw members are removably attached to respective first and second handles for interchanging with other types of jaw members.

8. A multi-purpose rescue tool, the tool comprising:
opposing cooperating first and second members;
a pivot defining a pivot point, the pivot pivotally connecting first and second members for movement towards and away from each other;
each first member and second member including corresponding working end portions that extend from proximately the pivot point in a generally forward longitudinal direction with respect to a central plane of the tool, the working end portions having opposing faces configured to open and close together for gripping, twisting, cutting, and rotating an object disposed therebetween;
each first member and second member including corresponding first and second handles that extend from proximately the pivot point in a generally rearward longitudinal direction with respect to the central plane of the tool;
a first wrench located at approximately an end portion of the first handle;
a finger protruding outwardly from the end portion of the first handle;
a cutting device located on one of the first and second handles for cutting material; and
a second wrench located at approximately an end portion of the second handle.

9. The tool according to claim 8, wherein the working end portions of first and second members define a pair of pliers.

10. The tool according to claim 9, wherein the pair of pliers are lineman's pliers.

11. The tool according to claim 9, wherein the pair of pliers include a pair of cutters for cutting wire.

12. The tool according to claim 8, wherein the working end portions of first and second members define a pair of sheet metal cutters.

13. The tool according to claim 8, wherein the first wrench has a generally trapezoidal shape with one end of the trapezoid being open, such that the first wrench accommodates a large variety of nut sizes including metric and English.

14. The tool according to claim 8, wherein the first wrench has a generally C-shaped configuration, the first wrench extending in a generally traverse direction with respect to a longitudinal axis of the first handle.

15. The tool according to claim 8, wherein the cutting device is located on the second handle and includes a hook portion with an open slot cutter, the open slot cutter includes a cutting edge portion for cutting seat belts.

16. The tool according to claim 8, wherein the second wrench defines a generally tapered shape having an opening for fitting over a plurality of different size valve controls for opening and closing the valve.

17. The tool according to claim 8, wherein the cutter is positioned at approximately midway between the working end portion and an end portion of the second handle.

18. The tool according to claim 8, wherein the end portion of the second handle is tapered and gradually slopes away from the central plane of the tool to define a pry-bar for prying opening doors and windows.

19. A multi-purpose rescue tool, the tool comprising:
a pair of opposing cooperative first and second jaw members;
a pair of first and second handles extending from respective pair of first and second jaw members for operating the pair of jaw members;
means for opening and closing the pair of jaw members for gripping, twisting, cutting, and rotating an object removably engaged therebetween;
means for turning on and off water and gas valves;
means for opening and closing fire hose connections and fire hydrants;
means for breaking glass;
means for cutting safety belts; and
means for prying open doors and windows.

20. The tool according to claim 19, further comprising a means for cutting wire.
